(19) United States
(12) Patent Application Publication
(10) Pub. No.: US 2005/0265017 A1
(43) Pub. Date: Dec. 1, 2005

(54) Electrical decoration-lighting device

(76) Inventors: Thomas Von Ronn, Hamburg (DE); Birgit Clemens, Hamburg (DE); Harald Rathman, Berlin (DE)

Correspondence Address: KENYON & KENYON, ONE BROADWAY, NEW YORK, NY, 10004, US

(21) Appl. No.: 10/993,650

(22) Filed: Nov. 19, 2004

(30) Foreign Application Priority Data
Sep. 2, 2004 (DE) 20 2004 013 829.8

(51) Int. Cl. F21L 4/00; F21L 4/04

(52) U.S. Cl. 362/194; 362/198

(57) ABSTRACT

A lighting device in which the current source is arranged at a spatial distance from the lighting body. The weight of the lighting body may be reduced accordingly, thereby increasing the stability of the lighting body when fastened to a supporting body.

### FIELD OF THE INVENTION

The present invention relates to an electrical decoration-lighting device and to a set of such lighting devices.

### BACKGROUND

Lighting devices are commonly used for decorative lighting, particularly for festive occasions. One such application is decorative lighting on a Christmas tree. Further applications are atmospheric lighting for celebrations or in the form of motif lighting for special holidays, semi-transparent decoration housings, for example, being slipped onto the lighting body so that they are illuminated from inside.

Lighting devices independent of an electrical network are known. For example, such lighting devices are described in German Patent Refs. DE 200 03 164 U1, DE 201 00 891 U1, DE 201 14 003 U1, DE 20 2004 000 124 U1, DE 200 20 560 A1, DE 41 13 442 A1, DE 198 14 231 A1, DE 102 06 418 A1 and DE 103 02 593 A1. Conventional household batteries or storage batteries, which are situated in the lighting body, are typically used as current sources. Because of the weight of these current sources, problems occur with respect to the stability of the lighting devices, particularly when attached to a supporting body, e.g. to a branch of a Christmas tree.

Thus, there is a need for a lighting device that exhibits improved stability when attached to a supporting body.

### SUMMARY OF THE INVENTION

The present invention, according to one embodiment thereof, provides a lighting device in which the current source is arranged at a spatial distance from the lighting body. The weight of the lighting body may be reduced accordingly, thereby increasing the stability of the lighting body when fastened to a supporting body.

The housing, according to one advantageous embodiment, is configured for arrangement suspended below the lighting body, e.g., a lower center of gravity of the total device. Preferably it is arranged below the attachment point. In this manner, the stability of the lighting device is increased, and improved alignment of the lighting body, e.g. in the upright operating position, is attained. In one embodiment, the attachment element may preferably allow the lighting device to swivel upon deflection out of the operating position. In this embodiment, it is preferable that the lighting device experiences a restoring force into the operating position.

Preferably, the connecting element is flexible, e.g., flexible plastic, a wire element, etc. This permits adaptation to different spatial conditions, especially with respect to the arrangement of the housing for the current source, as well as an adjustment of the center-of-gravity position. A flexible connecting element may also be used as an attachment element by bending it into a suitable shape. It is then possible to dispense with an additional attachment element, which greatly simplifies the overall design. A particularly simple form of attachment is the winding or looping of a flexible connecting element about the supporting body, e.g. a branch of a Christmas tree. For this purpose, the connecting element preferably has a length in the range of 2 to 20 cm, more preferably in the range of 5 to 15 cm.

According to a further aspect of the present invention, a set of lighting devices, having a plurality of the above-described lighting devices, is provided. A set, according to one embodiment of the present invention, has the feature that a separate current source may be assigned to each lighting device, so that wiring between the lighting devices or to a central current source may be omitted. The present invention may thus differ from a conventional string of lights for a Christmas tree, which, for example, is supplied with energy by a central battery independently of an electrical network.

In each lighting device, switches are preferably provided for switching the light-emitting elements on and off. In order to simplify the operator control, all the switches are preferably centrally operable along the lines of a remote control with the aid of a wireless transmitting device, e.g., are able to be switched on and off simultaneously.

If one of the lighting devices is preferably designed as a transmitting device, e.g., a suitable transmitter is integrated in one of the lighting devices of the set, then it is possible to dispense with a separate remote-control transmitting device. Operator control is simplified, since misplacement of the remote-control transmitting device is ruled out. Thus, there is provided, in one embodiment of the present invention, a set having a plurality of lighting devices, each lighting device including a switch for switching the light-emitting element on and off, whereby the switches of all the lighting devices are centrally operable using a wireless transmitting device, and wherein the transmitting device is integrated in one of the lighting devices of the set. In this embodiment, expenditure may be reduced and the operator control may be simplified.

In another embodiment, each lighting device of the set has a transmitting device, so that each lighting device may be used for switching the set on and off In this manner, it is not necessary to search for a specific lighting device having the transmitter. The operator control is thereby further simplified.

According to a further embodiment of the present invention, a holder for a decorative lighting fitting is provided, wherein the connecting element is flexible, preferably plastically flexible. This arrangement permits adaptation of the holder to different spatial conditions, particularly with respect to the arrangement of the weight, as well as an adjustment of the center-of-gravity position. In this embodiment, there is provided a holder for a candle-shaped lighting body, in which the expenditure is reduced and which allows simple, individually adaptable attachment to a supporting body.

### BRIEF DESCRIPTION OF THE DRAWINGS

Further advantages of the present invention may be evident with reference to the attached drawing illustrating several exemplary embodiments, in which:

FIG. 1 shows a schematic representation of a first lighting device, according to one embodiment of the present invention;

FIG. 2 shows a schematic representation of a second lighting device, according to one embodiment of the present invention;

FIG. 3 shows a schematic representation of a third lighting device, according to one embodiment of the present invention;

FIG. 4 shows a schematic representation of a fourth lighting device, according to one embodiment of the present invention;

FIG. 5 shows a schematic representation of a holder for a lighting fitting, according to one embodiment of the present invention;

FIG. 6 shows a schematic representation of a set having a plurality of lighting devices, according to one embodiment of the present invention; and

FIG. 7 shows a schematic representation of a further set having a plurality of lighting devices, according to one embodiment of the present invention.

### DETAILED DESCRIPTION

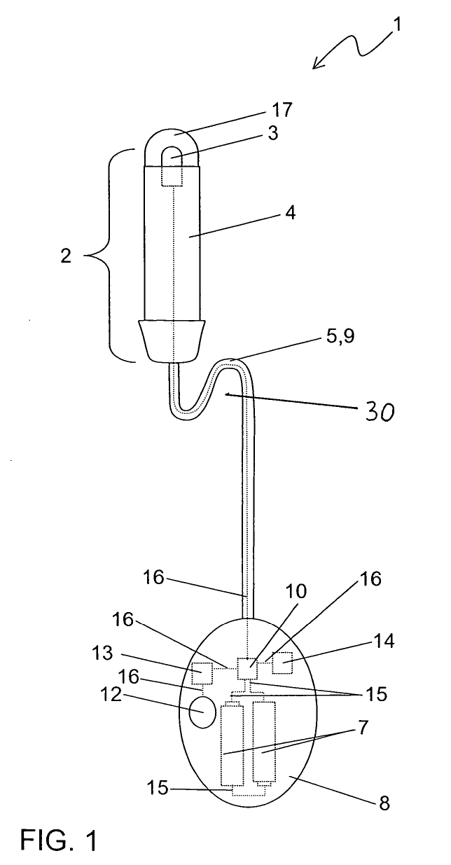

FIG. 1 illustrates a lighting device according to one embodiment of the present invention. An electrical decoration-lighting device 1 includes a lighting body 2, a connecting element 9 and a housing 8. The lighting body 2 includes a light-emitting element 3 and a shaft part 4. The light-emitting element 3 is an electrical lighting arrangement, e.g. an incandescent lamp or glow lamp, a small tubular fluorescent lamp or a light-emitting diode (LED). By preference, light-emitting diodes are operated in pulsed fashion, preferably using a suitable frequency, so that the change between bright and dark phases is not perceived by the observer. The maximum operational life may thereby be considerably prolonged.

The lighting device 1 has a connecting element 9 for connecting the lighting body 2 to a housing 8. An electrical line 16 for connecting the light-emitting element 3 to a current source 7 is provided within the connecting element 9. The electrical current source 7 is preferably formed by one or more dry cells, e.g. button cells, round miniature cells or rechargeable batteries. For example, two round cells may be provided for making a supply voltage of, for instance, 3 V available. Moreover, the electrical current source 7 serves, via the supply lines 16, as the power supply for the transmitter 13 and the receiver 14. For aesthetic purposes, the electrical lines 15, 16 are preferably disposed within the hollow connecting element 9, as well as within the lighting body 2 and the housing 8. The electrical current source 7 is situated within the housing 8. The power supply is interrupted by a switch 10 which, for example, may be an on-off switch or a multi-step or stepless switching element for setting different levels of brightness of the light-emitting element 3. The housing 8 may be designed as a decorative element.

The connecting element 9, in the specific embodiment of the present invention illustrated in FIG. 1, is rigid and has a loop 30 which is used for hanging on a supporting body, e.g., an essentially oblong supporting body 6, for instance, the branch of a Christmas tree. In this case, the connecting element 9 functions as the attachment element 5 at the same time. In this way, lighting device 1 is attached to supporting body 6 in a manner allowing lighting device 1 to swivel, such that even given a deflection, because of the low center of gravity, it swivels back again to the desired, e.g., upright, position. Fastening to other supporting bodies, e.g. nails, hooks or bands which are attached to other objects, etc., is also possible.

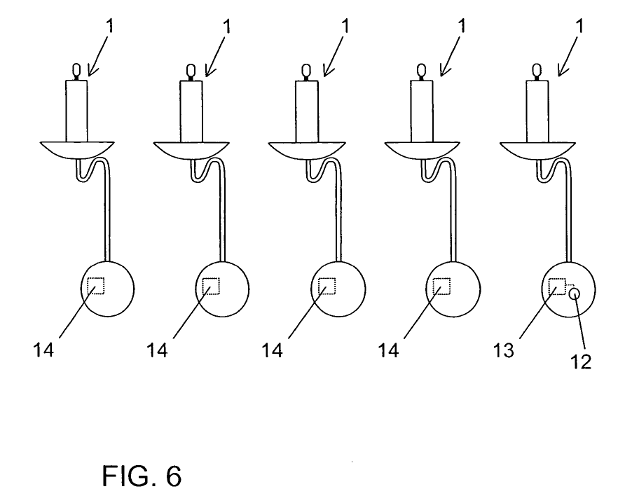

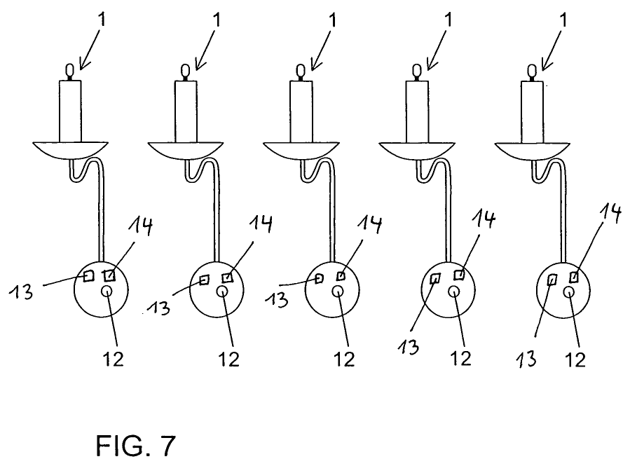

FIGS. 6 and 7 each show, in accordance with one embodiment of the present invention, a set having a plurality of lighting devices 9, for example, for decorating a Christmas tree. To switch all lighting devices 1 of the set on and off simultaneously, at least one lighting device 1 features remote-control means having a wireless transmitter 13 and an actuating element 12 conveniently arranged on the exterior of the housing 8; By operating the actuating element 12, an electromagnetic or acoustical signal is emitted by the transmitter 13. It is preferably a radio signal, for example, in the frequency band around 433 MHz. Any other type of signal, e.g., an infrared signal, an ultrasonic signal, etc., may also be used. For visual reasons, the transmitter 13 is preferably situated in the housing 8 in a manner that it is not visible.

The remaining lighting devices 1 of the set have a receiver 14 which is set up for receiving and detecting the signal sent by the transmitter 13. The receiver 14 is connected to the switch 10, and as a result of a received signal, switches the switch 10 in order to turn the lighting device 1 on or off or shift it to a specific operating state.

In the specific embodiment illustrated in FIG. 6, one lighting device 1 is designed as a transmitting device having a transmitter 13 and an actuating means 12, while the remaining lighting devices 1 of the set have a receiver 14, but no transmitter 13 (e.g., a master-slave configuration). The lighting device 1 having the transmitter 13 does not have to have a receiver 14 in this configuration if the switch 10 is operable by the actuating element 12.

In the specific embodiment illustrated in FIG. 7, all the lighting devices 1 of the set are constructed in accordance with FIG. 1, that is, each lighting device 1 has a transmitter 13, an actuating means 12 and a receiver 14. This specific embodiment has the advantage that each lighting device 1 may be used for switching the set on and off, and it is not necessary to search for a specific lighting device 1 designed as a transmitting device.

The transmitter 13, the receiver 14, the switch 10 and/or the actuating element 12 are preferably arranged on or in the housing 8 rather than on or in lighting body 2, so as to minimize its weight, thereby increasing the stability of lighting body 2 when attached to supporting body 6.

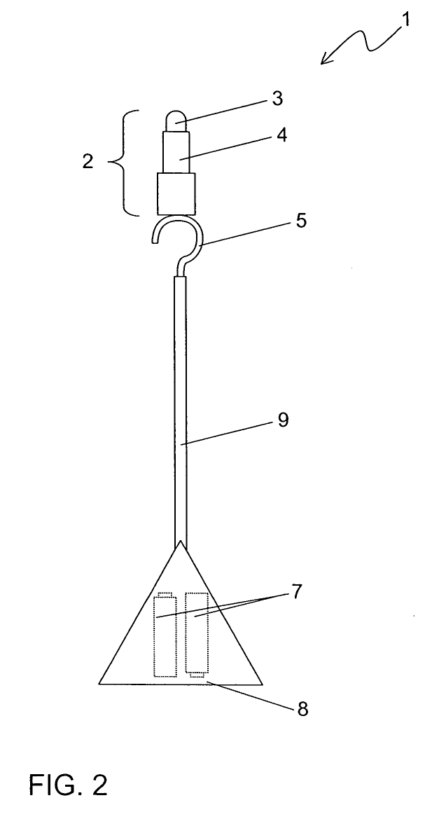

In the specific embodiment shown in FIG. 2, an attachment element 5 in the form of a hook is employed, which is used for hanging via the supporting body 6. Compared to the specific embodiment according to FIG. 1, this has the advantage of a centered suspension, thereby facilitating the adjustment of an upright position of the lighting body 2.

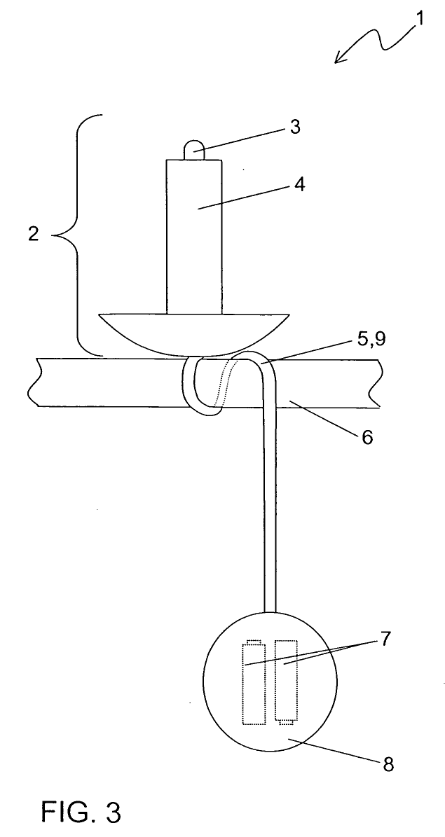

In the specific embodiment illustrated in FIG. 3, the attachment element 5 is formed by the connecting element 9. For this purpose, the connecting element 9 is plastically flexible, and exhibits sufficient rigidity to fasten the lighting body 2 on the supporting body 6 in stable fashion and to retain it in the desired position. To this end, for example, the connecting element 9 is looped once or several times around the supporting body 6. A suitable material for the connecting element 9 or parts thereof is, e.g., a wire.

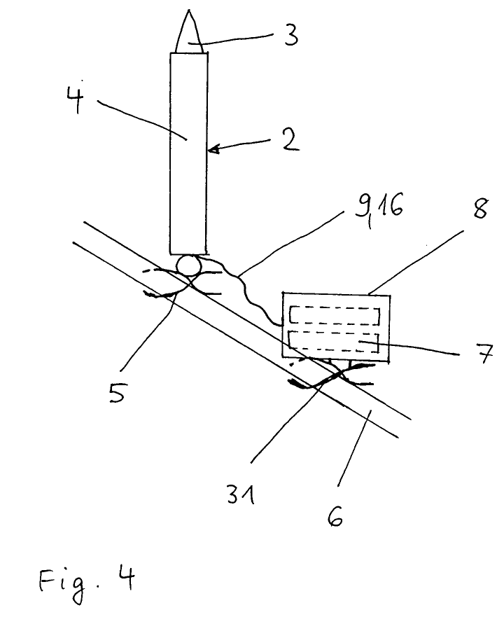

In the specific embodiment illustrated in FIG. 4, the lighting body 2 is attached by an attachment element 5 in the form, for instance, of a clip. The connecting element 9 is flexible and may be formed, for example, by electrical supply lines 16 between the lighting body 2 and the housing 8. The housing 8 has a separate attachment element 31. This has the advantage that, depending on the spatial conditions, the housing 8 may be placed independently of the lighting body 2 and may be hidden if desired. The connecting element 9 preferably has no rigidity, in order to facilitate the free placement of the housing 8. Separate attachment element 31 for the housing 8 may be eliminated, for instance, if the housing 8 is held in an Advent wreath.

It should be noted that the switching element 10, the lines 15, 16, the receiver 14 and, optionally, the transmitter 13 and the actuating means 12 are not illustrated in FIGS. 2 through 4 for the sake of simplicity.

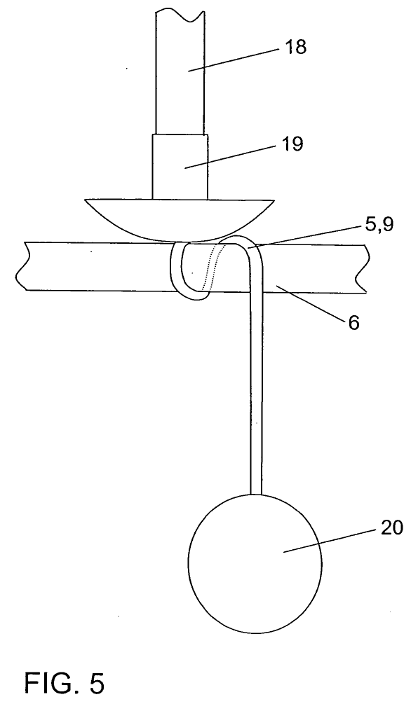

FIG. 5 shows, according to one embodiment of the present invention, a holder for a decorative lighting fitting 18, e.g. an electric candle or a wax candle. The holder includes a receiving means 19 for holding a lighting fitting 18, a weight 20 for retaining lighting fitting 18 in a stable position and a connecting element 9 for connecting the receiving means 19 to the weight 20. Corresponding to the specific embodiment shown in FIG. 3, the attachment element 5 is formed by the connecting element 9. The features described hereinabove with respect to FIG. 3 may also be present herein.

The lighting body 2 may be designed so that the visual impression of a traditional wax candle in a candle holder is achieved. For example, red, orange and/or yellow light emitting diodes may be used for this purpose. Ornamental elements, e.g. a candle plate, may be provided which is used with conventional candlesticks for catching dripping candle wax. Such decorative elements are represented by way of example in FIG. 1 or FIG. 3 at the lower end of the shaft part 4 of the lighting body 2. At the upper end of the shaft part 4, the lighting body 2 has a cap 17 for protecting the light-emitting element 3. The cap 17 may be in the form of a flame, for instance, or have additional visual elements such as color filters or lenses. However, the protective cap 17 may be optional.

Furthermore, the shaft part 4 of the lighting body 2 may be optional if, for example, the visual impression of an electric candle or a wax candle is not desired.

1. A lighting device, comprising
a lighting body having at least one electrically operated light-emitting element,
an attachment element for attaching the lighting device to a supporting body, and
an electrical current source which is independent of an electrical network and is assigned to the electrical lighting device for supplying power to the light-emitting element,
a housing, separate from the lighting body, for accommodating the electrical current source, the housing being designed for arrangement outside of and set apart from the lighting body and being connected to the lighting body by a connecting element.

2. The lighting device as recited in claim 1, wherein the housing is designed for arrangement suspended below the lighting body.

3. The lighting device as recited in claim 1, wherein the attachment element allows the lighting device to swivel.

4. The lighting device as recited in claim 1, wherein the connecting element is flexible.

5. The lighting device as recited in claim 1, wherein the connecting element includes a wire element.

6. The lighting device as recited in claim 1, wherein the attachment element is formed by the connecting element.

7. The lighting device as recited in claim 1, wherein the connecting element has a length in the range of 2 to 20 cm.

8. A set of lighting devices, wherein each one of a plurality of the lighting devices is as recited in claim 1.

9. The set as recited in claim 8, wherein each lighting device has a switch for switching the light-emitting element on and off.

10. The set as recited in claim 9, wherein the switches of all lighting devices are centrally operable by a wireless transmitting device.

11. The set as recited in claim 10, wherein the transmitting device is integrated in one of the lighting devices of the set.

12. The set as recited in claim 11, wherein each lighting device of the set has a wireless transmitting device.

13. The set as recited in claim 9, wherein at least one of the switch, the transmitting device, a corresponding receiver and a corresponding actuating element is arranged in or on the housing.

14. A holder for a decorative light fitting, comprising
a receiving means for accommodating the light fitting;
an attachment element for attaching the holder to a supporting body;
a weight that is configured to suspended via a connecting element below the receiving means and set apart from it, wherein the connecting element is flexible.

15. The holder as recited in claim 14, wherein the connecting element includes a wire element.

16. The holder as recited in claim 14, wherein the attachment element is formed by the connecting element.

17. The holder as recited in claim 14, wherein the connecting element has a length in the range of 2 to 20 cm
